(19) United States
(12) Patent Application Publication
(10) Pub. No.: US 2006/0241973 A1
(43) Pub. Date: Oct. 26, 2006

(54) System and Method for Employee Health and Productivity Improvement Plan

(75) Inventor: Dwight Harris, Beverly Hills, CA (US)

Correspondence Address: AKA CHAN LLP, 900 LAFAYETTE STREET, SUITE 710, SANTA CLARA, CA, 95050, US

(73) Assignee: Dwight Harris, Beverly Hills, CA (US)

(21) Appl. No.: 11/160,731

(22) Filed: Jul. 6, 2005

Related U.S. Application Data
(60) Provisional application No. 60/594,596, filed on Apr. 21, 2005.

(51) Int. Cl. G06Q 10/00; G06Q 50/00

(52) U.S. Cl. 705/2

(57) ABSTRACT

A system and method facilitates an employer to make tax-deferred payments into an employee's account as an incentive to live a healthier lifestyle. The system awards tax-deferred contributions to individuals based on accomplishments in a number of categories. Each category, such as exercise regimen, provides some indication of an individual's health. The system awards points on a predetermined scale for accomplishments in each of these categories. The system gathers data to a central processing location from various sources to calculate of an individual's score. Based on the score, the employer will contribute an amount of money into the individual's tax-deferred account. Thus, employees will have an incentive to improve their health.

### BACKGROUND OF THE INVENTION

The invention generally relates to the field of a computer-implemented employee benefit plan and tracking. In particular, the invention is related to a computer-based technique to implement and track a qualified & non-qualified plan of deferred compensation that encourages employee health and productivity.

The United States is at the height of a health-care crisis, both from the standpoint of our people becoming one of, if not, the most obese and inactive nation in the world, although it is also the most affluent nation in the world. The combination of overweight and inactive people is helping to drive up the incidences of getting sick, which drives up the cost of health care and health insurance.

More and more Americans are becoming uninsured because of the high cost, and more companies are having their profit base destroyed because of the high cost to insure them. The situation is truly out of hand. A Los Angeles Times article dated Apr. 6, 2005 mentions California's weight problem could lead to health expenses totaling $28.7 billion in 2005.

Furthermore, insurance premiums are increasing at a faster rate than the rate of workers' earnings. Between spring 2003 and spring 2004, premiums for employer-sponsored health insurance rose by 11.2 percent, lower than the 13.9 percent increase in 2003, but still the fourth consecutive year of double-digit growth. Premiums continued to increase much faster than overall inflation (2.3 percent) and wage gains (2.2 percent). There is a need for a system to help reduce the rate at health care costs are rising.

There are qualified plans where employers may make tax-deferred payments into an employee's account to help the employee save for retirement. However, there have been no qualified plans that uses the tax advantages of qualified plans to encourage their employees to both improve their personal health and to enable them to be more productive at the workplace.

Therefore, there is a need for a computer-implemented qualified plan that encourages employee health. This plan would help their employer reduce the cost of the health insurance programs, and reward them, financially, with all contributions not currently taxable to the employee, and growing on a tax-deferred basis, with an objective computer-implemented monitoring and verification process in place.

### SUMMARY OF THE INVENTION

The invention provides a system and method for an employer to make tax-deferred payments into an employee's account as an incentive to live a healthier lifestyle. The system awards tax-deferred contributions to individuals based on accomplishments in a number of categories. Each category, such as exercise regimen, provides some indication of an individual's health. The system awards points on a predetermined scale for accomplishments in each of these categories. The system gathers data and sends to a central processing location from various sources to calculate of an individual's score. Based on the score, the employer will contribute an amount of money into the individual's tax-deferred account. Thus, employees will have an incentive to improve their health.

The invention relates to an employer's involvement in assisting their employees to attain better levels of personal health, and greatly lower health care costs to the employer, and employees, thus resulting in the employer having more productive employees. An employer allocates some amount of money to a program, which will be given to employees as tax-deferred compensation. Since employees become healthier, the employer is expected to save money in health care benefit premiums.

In one implementation, the invention is a method including assigning a first score to the individual in a first health category, and assigning a second score to the individual in a second health category. The first score is compared against a previous score of the individual in the first health category, and generating a first improvement point value based on this comparison. The second score is compared against a previous score of the individual in the second health category, and generating a second improvement point value based on this comparison. The first improvement point value is added to the first score, and adding the second improvement point value to the second score. A final score may be obtained by adding the first and second scores together. Based on the final score, a contribution amount is determined to be placed the individual's tax-deferred account.

Some examples of the health categories include whether the individual is a smoker, weight of the individual, blood pressure of the individual, exercise regimen of the individual, and job performance or the individual. The scores, such as the first score, may be obtained via a network or other similar connection. For example, data about the individual, such as entry and exit times at a gym or health club, may be transmitted through phone or Internet lines to the central processing unit to help assess an exercise regimen score.

In another implementation, the invention is a computer-implemented method including assigning a first score in a first category to a first individual based on whether the first individual is a smoker or nonsmoker, assigning a second score in a second category to the first individual, and calculating a total score based on the first and second scores. Based on the total score, an amount of money may be determined to be allocated to the first individual. The amount of money may be placed in a tax-deferred account.

Further, when the first individual is a nonsmoker, the money amount allocated will typically be larger than when the first individual is a smoker, given the same second score. The second category may include at least one of a body mass index, blood pressure, exercise regimen, or productivity. When the second category is an exercise regimen, data may be received from a client computer at an exercise facility upon entry and exit of the facility by the first individual. When the second category is blood pressure, the second score may be determined using at least two measurements of the blood pressure of the first individual taken at different times during a time period, typically a year. By making more than one measurement, this helps prevent fraud on the system, and also provides a basis on which to determine whether the individual has made any improvement during the year.

The method may handle numerous individuals, even when the individuals work at different employers. The method will be able to organize the individuals by employer, so that an employer will be able to receive a report only for their employees. Furthermore, the method of the invention has security protocols to maintain confidentiality of the data of individuals. For example, the system may have an employer-accessible interface, such as through a web page. The employer will be only permitted to view information relating to the employer's employees and not the employees of other employers. Moreover, the system may have an employee-accessible interface, such as through a web page. The employee will be only permitted to view information relating to the employee, and not information for other employees.

The method may also account for improvements and include improvement points based on the amount of improvement. For example, the weight or other factor related to weight, such as a body mass index or BMI, may be one of the categories that are being tracked. When there is an improvement in weight or BMI (i.e., a reduction in weight) during the year, the individual will receive improvement points. If there has been a deterioration or worsening in a category, such as an increase in weight or BMI, then the individual may receive negative improvement points.

In another implementation, the invention is a system including a first client computer receiving first health information on a program participant and a second computer receiving second health information on the program participant. A central processing unit is connected to the first and second client computers, receives first information from the first client computer, and receives second information from the second client computer. A third client computer is connected to the central processing unit, receives from the central processing unit a calculated score for the program participant based on the first information and second information. Based on the calculated score, a money amount will be allocated to a tax-deferred account of the program participant. This money allocation may be an electronic funds transfer handled or initiated by the system of the invention.

In another implementation, the invention is a method including receiving information from a number of sources indicative of a health of each of a number of individuals, calculating scores for the individuals based on the information from the sources, and based on the scores, calculating money amounts in deferred compensation to allocate to each of the individuals. In method of the invention, an individual with better health will have generally have a higher score and will be allocated a greater money amount. Typically, an individual with a lower body mass index will have a greater money amount allocated than an individual with a higher body mass index, other factors being the same.

In an implementation, the money amount may also be based on at least one of compensation or position of the individual. For example, the chief executive officer of the company, for the same score, will generally be allocated more money than for example, a director at the company. A report is generated listing the calculated money amounts for individuals of an employer. A report is generated listing the scores for individuals of an employer.

Other objects, features, and advantages of the present invention will become apparent upon consideration of the following detailed description and the accompanying drawings, in which like reference designations represent like features throughout the figures.

### BRIEF DESCRIPTION OF THE FIGURES

FIG. 1 shows a simplified block diagram of an e-learning system implemented in a distributed computing network connecting a server and clients.

FIG. 2 shows a more detailed diagram of an exemplary client of the e-learning system.

FIG. 3 shows a system block diagram of a client computer system used to execute application programs such as a web browser or performance support tools for the e-learning system.

FIG. 4 shows a system of gathering data into a central processing system to calculate an individual's score in one or more health categories, relevant to implementing qualified plan for improving health.

FIG. 5 shows an employee maximum potential allotment according to a system of the invention.

### DETAILED DESCRIPTION

FIG. 1 is a simplified block diagram of a distributed computer network 100 which may be used in an implementation of the invention. Computer network 10 includes a number of client systems 113, 116, and 119, and a server system 122 coupled to a communication network 124 via a plurality of communication links 128. Communication network 12 provides a mechanism for allowing the various components of distributed network 100 to communicate and exchange information with each other.

Communication network 124 may include many interconnected computer systems and communication links. Communication links 128 may be hard wire links, telephone lines, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), Wi-Fi, vendor-specific protocols, customized protocols, and others. While in one embodiment, communication network 124 is the Internet, in other embodiments, communication network 124 may be any suitable communication network including a local area network (LAN), a wide area network (WAN), a wireless network, a intranet, a private network, a public network, a switched network, satellite, and combinations of these, and the like.

Distributed computer network 100 in FIG. 1 is merely illustrative of an embodiment incorporating the present invention and does not limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 may request information from a server system which provides the information. Or information from each of the clients may be uploaded to the server system for further processing. For this reason, server systems typically have more computing and storage capacity than client systems. However, a particular computer system may act as both as a client or a server depending on whether the computer system is requesting or providing information. Additionally, although the invention has been described using a client-server environment, it should be apparent that the invention may also be embodied in a stand-alone computer system, peer-to-peer system, and others.

According to an embodiment of the present invention, server system 122 gathers information from various sources across the network, stores, and performs calculations or makes determinations, or both, based on the data gathered. In an embodiment, the gathered data includes tracking information about individuals which are indicative of their overall activities to improve their health. As an example, a user's identification card is scanned or read via a client machine when the user entering and exits a health club. This information is uploaded to the server which tracks the number of times, frequency, or length of time, or any combination of these, of the behavior of the user at the health club. Further each machine within the health club may be equipped with a client system, which upon scanning or reading of the user's card, will track the user's utilization of a particular machine. And in some embodiments, the user's heart rate, breathing rate, blood pressure, and other bodily measurements may be monitored and recorded.

In an embodiment, server 122 is responsible for receiving information requests from client systems 113, 116, and 119, performing processing required to satisfy the requests, and for forwarding the results corresponding to the requests back to the requesting client system. The processing required to satisfy the request may be performed by server system 122 or may alternatively be delegated to other servers connected to communication network 124. In another embodiment, server 122 receives information from one or more client systems about one or more user and stores the information. They may be multiple servers doing data gathering. Further processing by the server is described in more detail below.

Client systems 113, 116, and 119 may gather data about users to be stored by the server system. Furthermore, client systems 113, 116, and 119 (which may be different from the clients used to gather user data) may also enable users to access and query information stored by server system 122. For example, this may include permitting a user to view the data gathered by the server. In a specific embodiment, a “web browser” application executing on a client system enables users to select, access, retrieve, or query information stored by server system 122. Examples of web browsers include the Internet Explorer browser program provided by Microsoft Corporation, the Netscape browser provided by Netscape Communications Corporation, an America Online, Incorporated company, Mozilla Firefox browser, and the Opera Web browser, by Opera Software.

FIG. 2 shows an exemplary client system of the present invention used in implementing a employee health and productivity improvement plan. In an embodiment, a user interfaces with the system through a computer workstation system, such as shown in FIG. 2. FIG. 2 shows a computer system 201 that includes a monitor 203, screen 205, cabinet 207, keyboard 209, and mouse 211. Mouse 211 may have one or more buttons such as mouse buttons 213. Cabinet 207 houses familiar computer components, some of which are not shown, such as a processor, memory, mass storage devices 217, and the like. Mass storage devices 217 may include mass disk drives, floppy disks, lomega ZIP™ disks, USB removable storage, magnetic disks, fixed disks, hard disks, CD-ROMs, recordable CDs, DVDs, DVD-R, DVD-RW, Flash and other nonvolatile solid-state storage, tape storage, reader, and other similar media, and combinations of these. A binary, machine-executable version, of the software of the present invention may be stored or reside on mass storage devices 217. Furthermore, the source code of the software of the present invention may also be stored or reside on mass storage devices 217 (e.g., magnetic disk, tape, or CD-ROM).

Furthermore, FIG. 3 shows a system block diagram of computer system 201 used to execute the software of the present invention. As in FIG. 2, computer system 201 includes monitor 203, keyboard 209, and mass storage devices 217. Computer system 501 further includes subsystems such as central processor 302, system memory 304, input/output (I/O) controller 306, display adapter 308, serial or universal serial bus (USB) port 312, network interface 318, and speaker 320. The invention may also be used with computer systems with additional or fewer subsystems. For example, a computer system could include more than one processor 302 (i.e., a multiprocessor system) or a system may include a cache memory.

Arrows such as 322 represent the system bus architecture of computer system 201. However, these arrows are illustrative of any interconnection scheme serving to link the subsystems. For example, speaker 320 could be connected to the other subsystems through a port or have an internal direct connection to central processor 302. Computer system 201 shown in FIG. 2 is but an example of a computer system suitable for use with the present invention. Other configurations of subsystems suitable for use with the present invention will be readily apparent to one of ordinary skill in the art.

Computer software products may be written in any of various suitable programming languages, such as C, C++, Pascal, Fortran, Perl, MatLab (from MathWorks, www.mathworks.com), SAS, SPSS, and Java. The computer software product may be an independent application with data input and data display modules. Alternatively, the computer software products may be classes that may be instantiated as distributed objects. The computer software products may also be component software such as Java Beans (from Sun Microsystems) or Enterprise Java Beans (EJB from Sun Microsystems). An operating system for the system may be one of the Microsoft Windows® family of operating systems (e.g., Windows 95, 98, Me, Windows NT, Windows 2000, Windows XP, Windows CE, Windows Mobile), Linux, UNIX, or Sun OS. Other operating systems may be used.

In an embodiment, with a web browser executing on a computer workstation system, a user accesses a health and productivity system on the World Wide Web (WWW), through a network such as the Internet. The web browser is used to download web pages or other content in various formats including HTML, XML, text, PDF, and postscript, and may be used to upload information to other parts (e.g., health and productivity server) of the health and productivity system. The web browser may use uniform resource identifiers (URLs) to identify resources on the web and hypertext transfer protocol (HTTP) in transferring files on the web.

As discussed above, there is a need to reduce the cost of health care and reduce the rate at which health care expenses and premiums. To facilitate reductions in health care costs, there need to be incentives for people to become healthier and take care of themselves better. Although a number of factors drive disease and sickness, one of the biggest is the way that we do, or do not, take care of ourselves and our physical well-being.

An estimated 129.6 million Americans, or 64 percent, are overweight or obese. Obesity and overweight conditions have been shown to increase the risk for developing type 2 diabetes, heart disease, some forms of cancer, and other disabling medical conditions. The total direct and indirect costs, including medical costs and lost productivity, were estimated at $117 billion nationally for 2000, according to the 2001 Surgeon General's Call to Action to Prevent and Decrease Overweight and Obesity.

There are various improvements to health care delivery and services that can correct many of the problems of sickness. However, many of these solutions cost a great deal of money and compound the problem by adding to the cost of the health care delivery system. Anecdotal evidence from an LA Times article shows that improved treatments cause a great increase in health care costs. A woman named Mary Vaughn had breast cancer, but through the help of the drugs Avastin and Herceptin, her cancer is has almost disappeared. The cost of her drugs is more than $8000 per month, more than she could afford, even with insurance.

A solution to this problem is to have employers get more involved in assisting employees to take better care of themselves. Reward employees for this improvement through tax-deferred payments to help with retirement. This can be accomplished with the Health and Productivity Improvement Plan (HAPI Plan), a specific embodiment of the invention.

FIG. 4 shows a more detailed diagram of an embodiment of a system for employee health and productivity improvement of the invention. The system includes a central processing unit that is linked to various components including gym/health club, personnel data collection personnel, laboratory, supervisors, and employer. In a client-server environment, the central processing unit may be a server and the various components are clients. This system is used in implementing a deferred compensation plan which rewards employees and individuals based on improvements in their health and productivity.

In a system of the invention, under a qualified plan (primarily 401A), employers make tax-deferred payments into an employee's account as an incentive to live a healthier lifestyle. This will drive down the cost of health care coverage at the same time of helping employees live much more productive lives for themselves, their families, and actually help the employer become even more profitable. The advantage is that it is hard to find a better motivator than money to cause change in people. When the tax deferral element is added, it compounds the effectiveness of the program. In fact this is advantageous for the entire country.

To implement a system of the invention, the employer would adopt a special type of deferred compensation plan, such as a profit sharing or other type plan qualified under IRS code section 401A, 403B, 409, 451, or 457. A plan implemented according to the invention will not discriminate against nonhighly compensated individuals. A specific implementation of this plan may be referred to as the “Employee Health & Productivity Improvement Plan” or the “HAPI Plan.”

In an embodiment of the invention, the employer would award tax-deferred contributions to its employees based on accomplishments in five categories: (1) smoking/nonsmoking, (2) normal weight ranges per height and sex, (3) blood pressure readings, (4) exercise regimens, and (5) job performance/productivity. This list provides merely examples of categories that may be used in a particular plan. In other embodiments of the invention, there may be more or fewer categories than above, and other categories that listed above may serve as a measure or indicator of an employee's health and productivity.

The employer would award points on a predetermined scale for accomplishments in each of these categories. However, so as to level the playing field, as well encourage improvements in productivity and worker health, a bonus “improvement” score will be created. Improvement will be calculated per category, on a graded system to allow for extra points (up to the category maximum) in each category. Thus, a worker who has a health problem will still be able to achieve his or her maximum total points, based on the ability to make strides in the desired direction. The five categories will be equally weighted, and the totals in each category will be added up using a computerized formula to achieve an individual's final score.

FIG. 4 shows a system of gathering data into a central processing system (which may have one or more computers) a calculation of an individual's score. Data may be gathered via a network, such as a local area network, wide area network, the Internet, phone network, or any data connection.

In an embodiment of the invention, there is a central processing unit per employer. For example, a employer that participates in a method of the invention purchases or licenses software which runs on the employer's server to act as the central processing unit to collect data and make calculations for the employer's employees. In another embodiment, the central processing unit is operated by an organization that implements a method of the invention for a number of employers. Collecting data, the central processing unit collects data for employees and organizes by employer. The employer may query the central processing unit to view its participants and their collected data.

The central processing unit collects data from numerous collection points. Some data collection points may include:

1. Health Club/Gym Membership Desk (Exercise regimen data)

2. Personal Data Collection Personnel (Blood Pressure data, Weight data, Samples for Smoker/Nonsmoker data)

3. Laboratory (Analysis of samples for Smoker/Nonsmoker data)

4. Supervisor (Job Performance/Productivity data)

At the health club or gym, the various data that may be collected include the number and amount of time a person has spent at the facility, or other factors to indicate the person's exercise regimen. Further, there may be data collection points at individual machines (such as stair steppers, treadmills, stationery cycles, rowing machine, cross-country skiing machine, and many others) to even further evaluate the person's health. The data collection points at individual machines may include sensors that a person wears while using the machine. The collected data may be sent directly to the central processing unit. Or this collected data may be sent to a collection unit at the health club. From the collection unit, the collected data is then sent to the central processing system. The data may be sent as soon as it is collected or may be sent at a specified time in a batch mode fashion.

In an embodiment, physical personal data is collected for each employee participant. This data may include information such as blood pressure data, weight data, samples for smoker or nonsmoker. In an implementation, a health or other practitioner will make the physical tests. The practitioner may do the physical tests at the health club or gym. Physical measurements will typically be made at least once a year. To prevent people from deceiving or cheating the system, the physical measurements may be done more than once a year, such as twice a year. Measurements may be made more than two times a year, such as three times a years or four times a year. However, twice a year is likely choice because it is less burdensome, but at the same time helps prevent fraud on the system.

A urine or blood test may be used to determine whether an individual is a smoker or nonsmoker. Since a urine test is generally less intrusive than a blood test, the urine test will likely be the test that more frequently selected by employees. The urine sample or blood test will be sent to a laboratory that will make a determination of whether an individual is a smoker (see connection between personal data collection box and laboratory box of FIG. 4). The smoking or nonsmoking determination may be sent to the central processing unit directly from the laboratory. Alternatively, the determination may be sent to the health, or other practitioner, who will send the data to the central processing unit.

Data is also gathered from the employee's supervisor, who will provide an assessment of the employee's job performance and productivity. The supervisor will give the employee a grade as to the employee's job performance and productivity.

The tallying of these scores will be automated via computerized formula at a central processing location, based upon the input from a couple of collection points. Each collection point will report the raw data via computer system, which will be calculated and converted into a whole number score in each of the categories above.

In a specific embodiment, the central processing system will automatically compile and score the data in the manner presented in the following table A. Accomplishments will be calculated per category, on a graded system to allow for extra points (up to the category maximum) in each category.

TABLE A

| Category | Score | Determinant |
|---|---|---|
| Smoker/Nonsmoker | 0 or x* | Nonsmoker receives max. score; smoker |
| | | receives 0 |
| Blood Pressure | 0 to x* | Deviation from accepted medical norms |
| Weight | 0 to x* | Deviation from accepted medical |
| Exercise Regimen | 0 to x* | Number of swipes at affiliated facility |
| Job Performance/ | 0 to x* | Score given by employee supervisor |
| Productivity | | |

The value “x” is a maximum category score, which may be any arbitrary selected value. For example, a maximum category score x may be 10. In a specific embodiment, the same maximum is given across all categories. Then each of the categories will be equally weighted. In other embodiments of the invention, the maximum category score may be different from other categories to allow a specific weighting for a specific category.

The central processing system will then compare the scores in each category to those of the previous measurement. Improvements will be measured and extra points allotted per category, based on a preapproved system for each category, which is illustrated in following table B. In an embodiment of the invention, a worker who has a health problem will still be able to achieve his or her maximum total points, based on the ability to make strides in the desired direction.

TABLE B

| | | | | Improvement |
|---|---|---|---|---|
| | | | | Points (as |
| | Previous | Current | Change in | determined |
| | Score | Score | Score | by formula |
| Category | (Ps) | (Cs) | (min. 0) | per category) |
| Smoker/Nonsmoker | 0 or x* | 0 or x* | (Cs) − (Ps) | 0 to x* |
| Blood Pressure | 0 to x* | 0 to x* | (Cs) − (Ps) | 0 to x* |
| Weight | 0 to x* | 0 to x* | (Cs) − (Ps) | 0 to x* |
| Exercise Regimen | 0 to x* | 0 to x* | (Cs) − (Ps) | 0 to x* |
| Job Performance/ | 0 to x* | 0 to x* | (Cs) − (Ps) | 0 to x* |
| Productivity | | | | |

The value “x” is a maximum category score, which may be any arbitrary selected value. For example, a maximum category score x may be 10. In a specific embodiment, the same maximum is given across all categories. Then each of the categories will be equally weighted. In other embodiments of the invention, the maximum category score may be different from other categories to allow a specific weighting for a specific category.

To determine improvement, using weight as an example, if a person weighed 250 pounds at a first physical measurement check and then weighed 200 pounds at a subsequent measurement check, the employee would get points for improving of their in weight.

Finally, central processing will create an adjusted score based on the scores of the most recent set of tests and the addition of the bonus improvement points. The adjusted total of each of these category scores is then tallied, and a final score is totaled. The table below illustrates how scores may be adjusted based on improvement.

For example, for a first blood pressure measurement, the person will receive a current score (Cs). At a subsequent time, a subsequent blood pressure measure is made, and the employee will give given improvement points (Ip) if there has been an improvement. The number of improvement points given will be based on a formula.

For example, the formula may give one improvement point for each two points improvement in blood pressure score. Other formulas may be used. The formulas may be linear, nonlinear, polynomial, exponential, empirically determined, or other. The formula may be maintained by the central processing unit using a look-up table or other data structure. This data structure may be stored in memory, disk, or nonvolatile storage.

Table C provides an example of how a current score may be adjusted by improvement points to obtain an adjusted score.

TABLE C

| | | Improvement Points | |
|---|---|---|---|
| | Current | (Ip) (as determined | |
| | Score | by formula per | Adjusted |
| Category | (Cs) | category) | Score (As) |
| Smoker/Nonsmoker | 0 or x* | 0 to x* | (Cs) + (Ip) |
| Blood Pressure | 0 to x* | 0 to x* | (Cs) + (Ip) |
| Weight | 0 to x* | 0 to x* | (Cs) + (Ip) |
| Exercise Regimen | 0 to x* | 0 to x* | (Cs) + (Ip) |
| Job Performance/ | 0 to x* | 0 to x* | (Cs) + (Ip) |
| Productivity | | | |
| | | | Final Score |

Tables D and E below provide an example of a specific implementation of a scoring system of the invention.

TABLE D

| Category | Range | HAPI Score |
|---|---|---|
| Smoker/Nonsmoker | Nonsmoker | 10 |
| | Smoker | 0 |
| Exercise Regimen | ≧5 | 10 |
| (Currently defined by the average | ≧4.5, <5 | 9 |
| number of visits per week to a | ≧4.0, <4.5 | 8 |
| participating gym over the course | ≧3.5, <4.0 | 7 |
| of a year*) | ≧3.0, <3.5 | 6 |
| | ≧2.5, <3.0 | 5 |
| | ≧2.0, <2.5 | 4 |
| | ≧1.5, <2.0 | 3 |
| | ≧1.0, <1.5 | 2 |
| | ≧0.5, <1.0 | 1 |
| | ≧0.0, <0.5 | 0 |

*A year to be considered 50 weeks or the total number of weeks employee worked during plan year

TABLE E

| Weight | | |
|---|---|---|
| BMI = [(Weight(lbs.)/height | ≧18.5, ≦25.0 | 10 |
| (in.)\hat{ }2] × 703 | >25.0, ≦26.0 | 9 |
| | >26.0, ≦27.0 | 8 |
| | >27.0, ≦28.0 | 7 |
| | >28.0, ≦29.0 | 6 |
| | >29.0, ≦30.0 | 5 |
| | >30.0, ≦31.0 | 4 |
| | >31.0, ≦32.0 | 3 |
| | >32.0, ≦33.0 | 2 |
| | >33.0, ≦34.0 | 1 |
| | >34.0, ≦35.0 | 0 |
| Blood Pressure | ≦120/80 | 10 |
| | 120-124/80-82 | 9 |
| | 125-129/83-84 | 8 |
| | 130-134/85-87 | 7 |
| | 135-139/88-89 | 6 |
| | 140-144/90-92 | 5 |
| | 145-149/93-94 | 4 |
| | 150-154/95-97 | 3 |
| | 155-159/98-99 | 2 |
| | 160-179/100-109 | 1 |
| | ≧180/110 | 0 |
| Productivity | | |
| As determined by supervisor | | 1-10 |

The scoring system above is a system where the higher the score means the person is healthier. In other embodiments of the invention, a different system may be used such as where a lower score means the person is healthier.

For table D, a nonsmoker gets a score of 10 while a smoker gets a score of 0. For the exercise regimen, the scoring is based on the average number of visits per week the person makes to a gym over the course of a year. In a specific implementation, a year is considered to be 50 weeks or the total number of weeks the employee worked during the year. However, in other implementation, other considerations may be used.

For table E, the person is assigned a weight score depending on a body mass index (BMI), which is given by weight in pounds divided by the square of the height in inches, multiplied by 703. In a specific implementation, when the BMI is less than 18.5, the person will receive a score of 10. However, in other implementations, other scores may be awarded. In other implementation of the invention, other indicators or indexes of a person's weight may be used besides the BMI.

A person is assigned a blood pressure score according to the person's systolic and diastolic measurements. The person is assigned a productivity score from 1 to 10 based on a supervisor's evaluation.

To implement a system of the invention, each year the employer designates an amount of its profits or money available for the health and productivity plan, such as the HAPI plan. For example, the employer may announce an amount allocated for the program, such as a percentage of profits or absolute amount, such as $2 million or $10 million. An employee will be given an allocation of the amount set aside for health and productivity plan based on the employee's participation and score as discussed above. The allocation may be a set amount or percentage depending on an employee's score. Information regarding the amount of money and how the money will be allocated among the users are sent to the central processing unit, which will perform the automated processing.

In an implementation of the invention, allocations of the amount of money set aside for wellness will be made purely on scores according to factors described above. This approach does not consider factors such as the employee's salary, or position of the employee, such as exempt or nonexempt.

The central processing unit uses the data collected for each employee to calculate scores. This data, as described above, includes the fitness regimen, physical data, supervisor grade, and others. The central processing unit calculates the score, including improvement, if applicable. The central processing unit can give scores to the employer and employee. The central processing unit may calculate scores for each of the employees of the employer, and apply the allocation formula to determine the allocated amount for each employee. This information would be supplied to the employer. Furthermore, the system may be accessible by the employee or employee, or both, so they may view scores and data during the year as it is updated. Periodically, the system may generate reports to let the employees see where they stand. The money allocated to an employee would be placed in a deferred compensation account for the employee.

In another implementation of the invention, each employee will have a maximum allocation or contribution possible. This maximum will be determined by a combination of the employee's present salary, as well as the employee's position within the company. Each employee can obtain the employee's maximum allocation with a perfect final score on the HAPI Plan. The actual benefit amount will be in direct proportion to the final score awarded to this individual (as expressed as a percentage).

As shown in FIG. 5, in essence, each employee will have a maximum benefit that he or she can achieve, independent of the performance of any fellow colleagues. The amount each employee actually has allocated to each his or her account will be determined by his or her performance in the categories measured by the HAPI plan.

The program would employ an objective monitoring and verification system to determine the point awards for each employee who chooses to participate. The program would be completely voluntary on the employee's part. The employee may choose to participate or not in the health and productivity plan.

Below is a representative flow of operation of an implementation of a system of the invention.

1. For each employer, choose money amount to allocate for HAPI program.

2. Select one or more categories to monitor.

3. Enroll employees.

4. Monitor fitness and health of employee during a period of time.

5. Calculate scores for each employee, taking into consideration improvement, if any, during the period of time.

6. Determine amount of money each employee receives based on score.

7. Place money in deferred compensation account for employee.

In this flow, for each employer that wants to implement a tax-deferred health and productivity improvement plan, they will select an amount of money to allocate into the plan. This money is input to the central processing unit. The employer will select which categories of data for the system to monitor. Described above were some exemplary categories. There may be other categories not specifically mentioned in this application, and only one or a subset of the categories discussed in this application may be used in a specific implementation of the system. Further, different employers may choose to monitor different categories from one another. So, for example, one employer may choose to monitor gym usage while another employer chooses not to monitor gym usage, but monitors only physically measured values. All this data may be input into the system (e.g., central processing unit) via a user-friendly interface, such as a web page.

Each employee who chooses to participate in the program is enrolled in the system. Then information from various data gathering sites, such as health clubs, will be sent to be stored in the system for each participant of each company. As discussed above, there may be a central processing unit that is used for individuals from a single company or from multiple companies. The system keeps and calculates scores for each individual based on the data gather. The system may provide progress and summary reports to each individual, or reports for all the employees of a particular employer or company.

A program typically runs from year to year. Money is set aside by the company at the beginning of a year and then paid as deferred compensation to participant employees at the end of the year. The year or time period may be a calendar year, or may begin at any arbitrary starting point and run year to year from that point. Also the program may run using a time period other than a year in length, such as half a year or two years. The time period is selectable through the system.

At the end of the year or other time period, the system makes a calculation, according to the formula provided to the system by the employer, of how much money each participant will be given based on the participant's scores. The system may generate a report including these numbers for the employer. In another embodiment of the invention, the system does the calculations and handles making the electronic transactions to transfer the appropriate money into each participant's tax deferred account.

When an employer implements a system of health and productivity improvement such as described in this patent application, it is expected that the employer will save money in the long term. Although the system of the invention requires the employer to set some money aside for the program and paid to participants, it is expected that there will be substantial savings in the health care premiums of the participants that will lower the overall cost to the employer, and possibly, the employee, if the employee makes a health premium contribution.

Health care costs are increasing every year. Even with advanced treatments, costs continue to soar. The causes of disease and sickness are largely preventable and certainly can be curbed or controlled. With the involvement of both employer and employee significant impact can be seen on both the health of the employee and the cost of their health care. The HAPI plan can establish and maintain such a program, while improving productivity and saving money, with minimal cost and great ROI.(Return on investment).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

What is claimed is:

1. A method comprising:
assigning a first score to the individual in a first health category;
assigning a second score to the individual in a second health category;
comparing the first score against a previous score of the individual in the first health category, and generating a first improvement point value based on this comparison;
comparing the second score against a previous score of the individual in the second health category, and generating a second improvement point value based on this comparison; and
adding the first improvement point value to the first score, and adding the second improvement point value to the second score.

2. The method of claim 1 further comprising:
adding the first score to the second score to obtain a final score.

3. The method of claim 2 further comprising:
based on the final score, determining a contribution amount to the individual's tax-deferred account.

4. The method of claim 1 wherein the first health category comprises at least one of whether the individual is a smoker, weight of the individual, blood pressure of the individual, exercise regimen of the individual, or job performance or the individual.

5. The method of claim 1 further comprising:
gathering data to assign the first score through a network connection.

6. A computer-implemented method comprising:
assigning a first score in a first category to a first individual based on whether the first individual is a smoker or nonsmoker;
assigning a second score in a second category to the first individual;
calculating a total score based on the first and second scores; and
determining a money amount to allocate to a tax-deferred account of the first individual based the total score.

7. The method of claim 6 wherein when the first individual is a nonsmoker, the money amount allocated is larger than when the first individual is a smoker.

8. The method of claim 6 wherein the second category is at least one of a body mass index, blood pressure, exercise regimen, or productivity.

9. The method of claim 6 further comprising:
when the second category is an exercise regimen, receiving data from a client computer at an exercise facility on entry and exit of the facility by the first individual.

10. The method of claim 6 further comprising:
when the second category is a blood pressure, determining the second score using at least two measurements of the blood pressure of the first individual taken at different times during a time period of the method.

11. The method of claim 6 further comprising:
assigning a third score in the first category to a second individual based on whether the first individual is a smoker or nonsmoker;
assigning a fourth score in the second category to the first individual;
calculating a total score based on the third and fourth scores; and
determining a money amount to allocate to a tax-deferred account of the second individual based the total score.

12. The method of claim 6 further comprising:
when the second category is a body mass index, determining the second score using at least two measurements for the first individual at different times during a time period for the method; and
when the body mass index for the first individual improves during the time period, assigning improvement points in the second category to the first individual.

13. A system comprising:
a first client computer receiving first health information on a program participant;
a second computer receiving second health information on the program participant;
a central processing unit, coupled to the first and second client computers, receiving first information from the first client computer, and second information from the second client computer; and
a third client computer, coupled to the central processing unit, receiving from the central processing unit a calculated score for the program participant based on the first information and second information, whereby based on the calculated score, a money amount is allocated to a tax-deferred account of the program participant.

14. The system of claim 13 wherein the first client computer is at at least one of a health club, gym, or exercise facility.

15. The system of claim 13 wherein the first client computer and second client computer are connected to the central processing unit via at least one of a digital data network, telephone lines, the Internet, or a wireless network.

16. A method comprising
receiving information from a plurality of sources indicative of a health of each of a plurality of individuals;
calculating scores for the individuals based on the information from the plurality of sources; and
based on the scores, calculating money amounts in deferred compensation to allocate to each of the individuals.

17. The method of claim 16 wherein an individual with better health will have a higher score and will be allocated a greater money amount.

18. The method of claim 16 wherein an individual with a lower body mass index will have a greater money amount than an individual with a higher body mass index.

19. The method of claim 16 wherein the money amount is also based on at least one of compensation or position of the individual.

20. The method of claim 16 wherein the information comprises at least one of weight, height, blood pressure, exercise regimen, smoker or nonsmoking, or productivity score assigned by a supervisor of the individual.

21. The method of claim 1 6 further comprising:
generating a report listing the calculated money amounts for individuals of a employer.

22. The method of claim 1 6 further comprising:
generating a report listing the scores for individuals of a employer.
